(19) United States
(12) Patent Application Publication
(10) Pub. No.: US 2012/0236995 A1
(43) Pub. Date: Sep. 20, 2012

(54) Automated Imaging Contrast Agent Determination System

(76) Inventors: Christian Eusemann, Malvern, PA (US); Bernhard Schmidt, Furth (DE)

(21) Appl. No.: 13/152,317

(22) Filed: Jun. 3, 2011

Related U.S. Application Data
(60) Provisional application No. 61/453,714, filed on Mar. 17, 2011.

(51) Int. Cl. H05G 1/44

(52) U.S. Cl. 378/108

(57) ABSTRACT

A system automatically adaptively determines contrast agent administration parameters for use in a CT scan imaging system. The system includes a repository, input processor, imaging processor and output processor. The repository includes predetermined information associating, a contrast agent type, contrast agent administration parameters, an imaging system X-ray tube voltage and at least one of, (a) a type of imaging procedure and (b) an anatomical region to be imaged. The input processor receives data identifying a type of imaging procedure or an anatomical region to be imaged. The imaging processor uses the information in automatically identifying contrast agent parameters and X-ray tube voltage in response to the received data. The output processor provides output data to a destination device indicating contrast agent parameters for use in administering contrast agent to a patient.

This is a non-provisional application of provisional application Ser. No. 61/453,714 filed Mar. 17, 2011, by C. Eusemann et al.

### FIELD OF THE INVENTION

This invention concerns a system for automatically adaptively determining contrast agent administration parameters for use in an X-ray radiation imaging system for acquiring data representing individual images of patient anatomy in the presence of a contrast agent.

### BACKGROUND OF THE INVENTION

It is desirable to reduce Radiation Dosage in X-ray and Computed Tomography (CT) imaging and also to reduce quantity of contrast agent introduced into a patient. Contrast agents are often costly and may not be well tolerated by particular patients with particular medical conditions. In known ionizing radiation imaging systems current (mAs) associated with an X-ray tube (acceleration) voltage is adjusted based on a topogram image acquired by a CT system comprising a 2D projection image acquired to determine the range of the CT scan to be acquired and based on data gathered during an actual patient scan. Known systems fail to optimize radiation dose and contrast agent selection. Known systems require a user to determine a contrast agent administration protocol which is a time consuming and burdensome task prone to error. A system according to invention principles addresses these problems and related problems.

### SUMMARY OF THE INVENTION

An ionizing radiation imaging system adaptively selects a contrast agent type, contrast agent amount and flow rate as well as X-ray tube voltage and associated current for imaging a particular anatomical feature. A system automatically adaptively determines contrast agent administration parameters for use in an X-ray radiation imaging system for acquiring data representing multiple individual images of patient anatomy in the presence of a contrast agent. The system includes a repository, input processor, imaging processor and output processor. The repository includes predetermined information associating, a contrast agent type, contrast agent administration parameters, an imaging system X-ray tube voltage and at least one of (a) a type of imaging procedure and (b) an anatomical region to be imaged. The input processor receives data identifying a type of imaging procedure or an anatomical region to be imaged. The imaging processor uses the information in automatically identifying contrast agent parameters and X-ray tube voltage in response to the received data. The output processor provides output data to a destination device indicating contrast agent parameters for use in administering contrast agent to a patient.

### BRIEF DESCRIPTION OF THE DRAWING

FIG. 1 shows a system for automatically adaptively determining contrast agent administration parameters for use in an X-ray radiation imaging system for acquiring data representing individual images of patient anatomy in the presence of a contrast agent, according to invention principles.

FIG. 2 shows a graph illustrating increase in CT Number with decreasing tube Voltage.

FIGS. 3 and 4 show tables (e.g., look-up tables) comprising a repository of predetermined information mutually associating parameters used in automatically identifying contrast agent parameters and X-ray tube voltage for use in imaging, according to invention principles.

FIG. 5 shows a flowchart of a process used by a system for automatically adaptively determining contrast agent administration parameters for use in an X-ray radiation imaging system for acquiring data representing individual images of patient anatomy in the presence of a contrast agent, according to invention principles.

### DETAILED DESCRIPTION OF THE INVENTION

An ionizing radiation imaging system adaptively selects a contrast agent, contrast agent amount and flow rate as well as X-ray tube voltage and current for imaging a selected anatomical feature. The system advantageously reduces contrast agent dosage and associated cost and associated contrast agent side effects whilst concurrently providing images of desired quality.

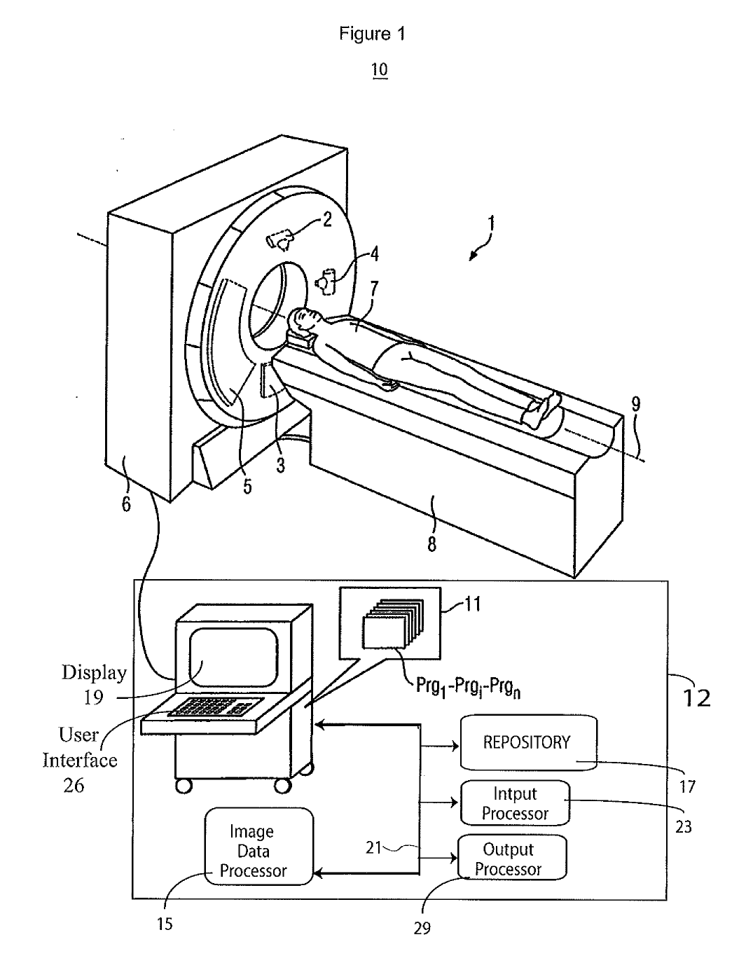

FIG. 1 shows CT imaging system 1 for automatically adaptively determining contrast agent administration parameters for use in an X-ray radiation imaging system for acquiring data representing individual images of patient anatomy in the presence of a contrast agent. CT system 1 has a gantry housing 6 and a displaceable patient support table 8 and includes processing unit 12 (e.g., a workstation or portable device such as a notebook, Personal Digital Assistant, phone) for operating the CT system and performing image data processing. Processing unit 12 includes at least one repository 17, image data processor 15, input processor 23 and output processor 29. A patient 7 is located on displaceable patient support table 8 that is movable during a scan along system axis 9 through a measuring field between X-ray tube 2 and X-ray radiation detector 3 opposite the tube across the CT imaging unit bore, while the X-ray tube 2 and the detector 3 move in a fashion rotating about the patient 7. CT system 1 supports spiral, axial and other scanning modes for imaging patient 7. Multiple X-ray tubes exemplified by second X-ray tube 4 and the detector 5 lying opposite may be used for scanning.

In order to control the CT system 1 and to evaluate the detector data received, computer programs (machine readable instructions) Prg1 to Prgn are executed by processing unit 12 to perform methods supporting operation of system 1. Prg1 to Prgn are stored in memory 11 in processing unit 12. Processing unit 12 includes display 19 for presenting output data provided by the system. Unit 12, or one or more other units of system 1 inter-communicating via network 21, store predetermined information in at least one repository 17. The information mutually associates, a contrast agent type, contrast agent administration parameters, X-ray tube voltage and at least one of, (a) a type of imaging procedure and (b) an anatomical region to be imaged. Input processor 23 receives data identifying a type of imaging procedure or an anatomical region to be imaged. Image data processor 15 further uses the information in automatically identifying contrast agent parameters to substantially minimize contrast agent quantity or flow rate for administration to a patient and identifies an X-ray tube voltage, providing adequate image quality for the type of imaging procedure and anatomical region to be imaged in response to the received data. Output processor 29 provides output data to a destination device indicating contrast agent parameters for use in administering contrast agent to a patient.

Processing unit 12 includes a user interface control device 26 such as a keyboard, mouse, touchscreen and voice data entry and interpretation device. System 1 comprises a CT scan (or in another embodiment an X-ray) modality imaging system and provides patient medical images. The medical images are generated in response to predetermined user (e.g., physician) specific preferences. At least one repository 17 stores medical image studies for multiple patients in DICOM compatible (or other) data format. A medical image study individually includes multiple image series of a patient anatomical portion which in turn individually include multiple images. In alternative arrangements, one or more of the units in unit 12 may be located on another device connected to network 21.

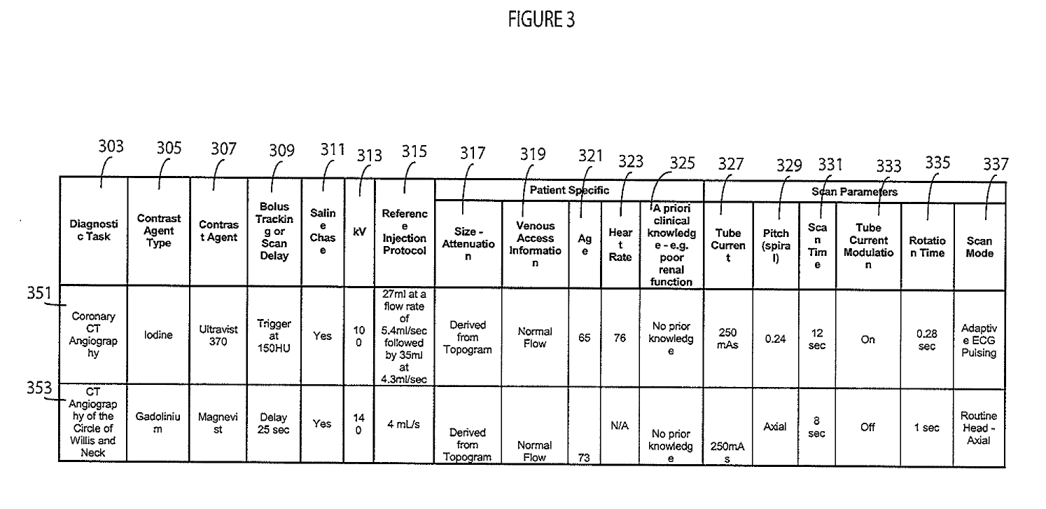

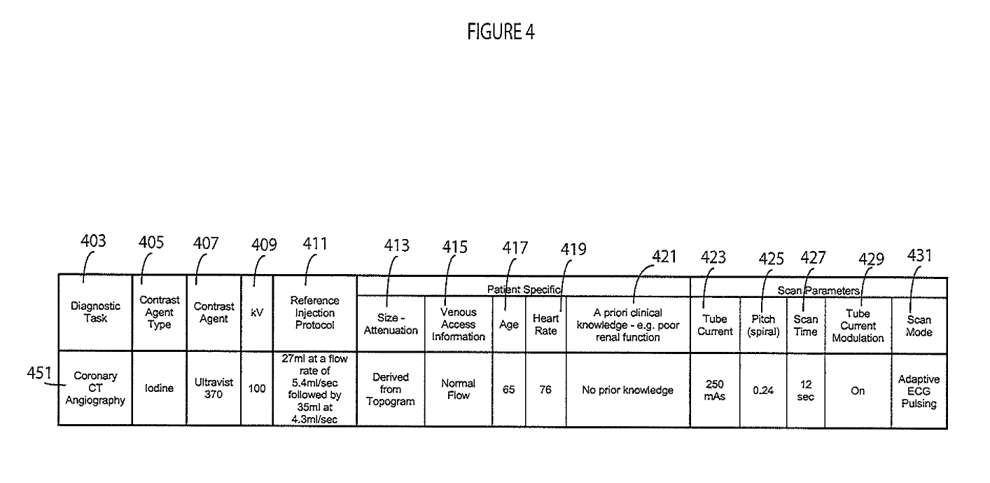

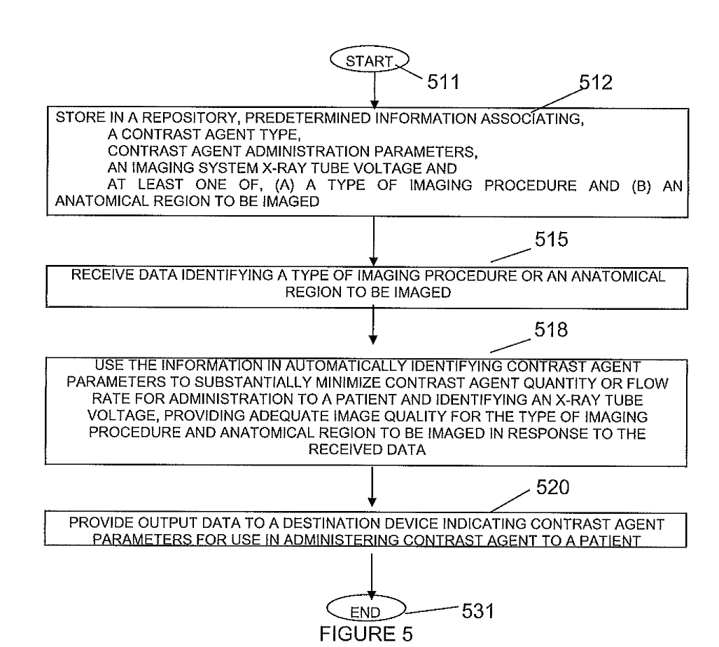

FIG. 5 shows a flowchart of a process used by system 1 including a CT scan or X-ray imaging system, for example, for automatically adaptively determining contrast agent administration parameters for use in an X-ray radiation imaging system for acquiring data representing individual images of patient anatomy in the presence of a contrast agent. In step 512 following the start at step 511, unit 12 stores predetermined information in repository 17. Predetermined information in repository 17, associates contrast agent administration parameters providing a substantially minimum contrast agent quantity for administration with a substantially minimum imaging system X-ray tube voltage providing adequate image quality for the type of imaging procedure and anatomical region to be imaged. The predetermined information in repository 17, also associates multiple different contrast agent types with a plurality of patient specific parameters and image scanning parameters. The information mutually associates, a contrast agent type, contrast agent administration parameters comprising a substantially minimum contrast agent flow rate, an imaging system X-ray tube voltage, a type of imaging procedure and an anatomical region to be imaged. FIGS. 3 and 4 show tables (e.g., look-up tables) stored in repository 17 comprising a repository of predetermined information mutually associating the parameters. These tables are used in automatically identifying contrast agent parameters and X-ray tube voltage for use in imaging.

Specifically, the table of FIG. 3 comprises a look-up table mapping and mutually associating, data indicating diagnostic task 303, contrast agent type 305, contrast agent 307, imaging delay from start of introduction of contrast agent 309, whether saline is introduced following the contrast agent 311, X-ray tube voltage 313 and contrast agent injection protocol and flow rate 315 together with patient specific parameters 317-325 and imaging scan parameters 327-337, for two different types of imaging procedure comprising the data on rows 351 and 353 respectively. The patient specific parameters are automatically acquired by unit 12 from a medical record of a patient and comprise patient size based X-ray radiation attenuation factor 317, venous access information 319, age 321, heart rate 323 and patient medical condition factors 325 (e.g., indicating impaired renal function). The imaging scan parameters comprise X-ray tube current 327, pitch for spiral acquisition 329, imaging scan time 331, data indicating whether or not X-ray tube current modulation is used 333, time for a complete image scan rotation 335 and scanning mode 337. The two different types of imaging procedure comprise a coronary CT angiography scan using an Iodine contrast agent indicated on row 351 and a neck CT angiography scan using a Gadolinium contrast agent indicated on row 353.

The table of FIG. 4 similarly comprises another embodiment of a look-up table mapping and mutually associating, data indicating diagnostic task 403, contrast agent type 405, contrast agent 407, X-ray tube voltage 409, and contrast agent injection protocol and flow rate 411 together with patient specific parameters 413-421 and imaging scan parameters 423-431, for an imaging procedure comprising the data on row 451. The patient specific parameters are automatically acquired by unit 12 from a medical record of a patient and comprise patient size based X-ray radiation attenuation factor 413 derived from a topogram acquired by the CT system and comprising a 2D projection image acquired to determine the range of the CT scan to be acquired and based on data gathered during an actual patient scan. The patient specific parameters also include venous access information 415, age 417, heart rate 419 and patient medical condition factors 421 (e.g., indicating impaired renal function). The imaging scan parameters comprise X-ray tube current 423, pitch for spiral acquisition 425, imaging scan time 427, data indicating whether or not X-ray tube current modulation is used 429 and scanning mode 431.

In step 515 (FIG. 5), input processor 23 (FIG. 1) receives data identifying a type of imaging procedure or an anatomical region to be imaged (e.g., 303 FIG. 3). Image data processor 15 in step 518 uses the information in automatically identifying contrast agent parameters including contrast agent type (305 FIG. 3), specific contrast agent (307), bolus imaging delay from start of introduction of agent bolus (309), injection protocol and flow rate (315) to substantially minimize contrast agent quantity or flow rate for administration to a patient. Processor 15 further identifies X-ray tube voltage (313), providing adequate image quality for the type of imaging procedure and anatomical region to be imaged in response to the received data. Image data processor 15 also automatically acquires from a medical record of the patient to be imaged, patient information (e.g. patient size (attenuation), age, heart rate, height, weight, gender, pregnancy status, vessel condition and diagnostic information indicating a medical condition of the patient and other patient specific factors) and also uses other scan parameters (e.g. higher pitch allows for scanning with shorter contrast bolus). Processor 15 uses the information in automatically selecting a substantially minimum contrast agent quantity or flow rate and imaging system X-ray tube voltage in response to the received data and a selected image scanning parameter comprising at least one of, (a) an X-ray tube current, (b) pitch, (c) scan time, (d) tube current modulation, (e) rotation time and (f) scan mode.

Image data processor 15 in response to the received data, uses the information in automatically identifying the substantially minimum contrast agent quantity and flow rate and imaging system X-ray tube voltage in response to the received data and parameters of the specific patient to be imaged. Processor 15 further automatically selects a type of contrast agent from the plurality of different contrast agent types and imaging system X-ray tube voltage in response to the received data.

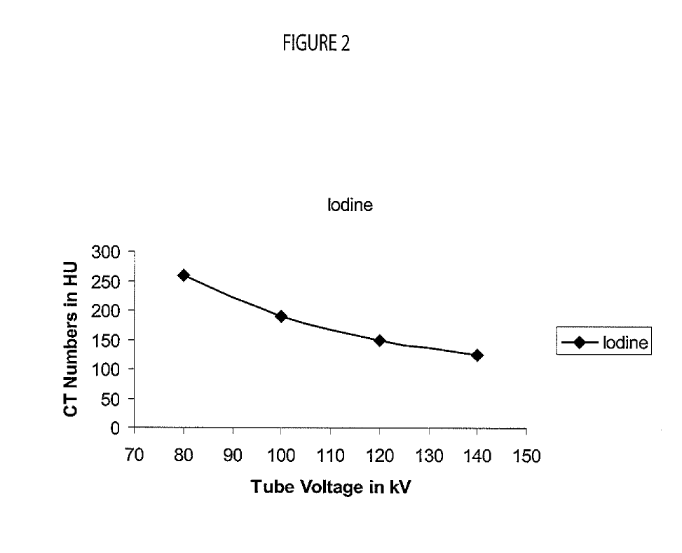

FIG. 2 shows a graph illustrating increase in CT Number (in Hounsfield units) with decreasing X-ray tube Voltage. A Hounsfield unit is an arbitrary unit of X-ray attenuation used for CT scans and for which each voxel is assigned a value on a scale in which air has a value of −1000; water, 0; and compact bone, +1000. The CT number is a selectable scan factor based on the Hounsfield scale. Each elemental region of a CT scan image (e.g., a pixel) is expressed in terms of Hounsfield units (HU) corresponding to the X-ray attenuation (or tissue density). CT numbers are displayed as gray-scale pixels on the viewing monitor. White represents pixels with higher CT numbers (bone). Varying shades of gray are assigned to intermediate CT numbers e.g., soft tissues, fluid and fat. Black represents regions with lower CT numbers like lungs and air-filled organs. The inventors have advantageously recognized that increasing CT number and image resolution at lower X-ray tube voltage as illustrated in FIG. 2, advantageously enables reduction in contrast agent quantity and flow rate at lower X-ray tube voltage whilst maintaining image quality. Further that imaging scans may be conducted using a lower contrast injection concentration and flow rate, for lower kV settings.

System 1 FIG. 1 advantageously limits X-ray tube voltage and current limiting the X-ray radiation dosage of a patient. Changing X-ray tube voltage (kV) setting in an X-ray, CT scan imaging system affects image quality, radiation dosage, and mass of patient that can be effectively scanned. For example, when lowering the kV setting from 120 kV to 80 kV, both the image contrast resolution and noise level increases. In addition, a scan at 80 kV provides a substantially lower radiation dose level than one at 120 kV, for example. A dose level and contrast-to-noise ratio (CNR) are also dependent on selected X-ray tube current. However the inventors have advantageously recognized that a patient may be scanned at 80 kV X-ray tube voltage without major artifacts and delivers a lower radiation dose than when the patient is scanned at 100 kV, 120 kV, or 140 kV. One known CT imaging system manufactured by Siemens selects an X-ray tube voltage kV level for a specific image acquisition, based on information derived from a patient topogram. The known system selects an optimal kV setting for each patient and utilizes information from a topogram and specific selectable presets that are used to identify an X-ray tube kV setting for specific scan types. For example, a CT Angiography scan (CTA) may accommodate more noise than a liver scan, hence the system may recommend a lower kV for a CTA than for a liver scan (same patient). The known system suggests X-ray tube voltage kV, Quality Reference mAs, and pitch (e.g., for multi-detector row CT scanning, pitch comprises table travel per rotation divided by the collimation of an X-ray beam). The known system advantageously lowers X-ray tube kV setting from 120 kV to 80 kV, for example, and resulting image luminance contrast resolution and noise level increase. The reduced 80 kV voltage scan substantially lowers radiation dose level.

The radiation dose level and CNR are also dependent on the selected X-ray tube current (mAs), but the inventors have advantageously recognized that contrast agent dosage may be lowered and image quality at 80 kV (in comparison with 120 kV, for example) is not substantially impaired. Further, the radiation dose is also reduced. In addition, to the radiation dose reduction resulting from the reduced X-ray tube kV, system 1 (FIG. 1) advantageously determines a decreased contrast agent flow rate and quantity and/or changed contrast agent injection protocol using the predetermined mapping information of FIG. 3.

Continuing with the flowchart of FIG. 5, in step 520 output processor 29 provides output data to a destination device indicating contrast agent parameters including contrast agent type (305 FIG. 3), specific contrast agent (307), bolus imaging delay from start of introduction of agent bolus (309), injection protocol and flow rate (315) to substantially minimize contrast agent quantity or flow rate for use in administering contrast agent to a patient. The process of FIG. 5 terminates at step 531.

System 1 (FIG. 1) is applicable for use with both positive and negative contrast agents and for imaging modality devices utilizing ionizing radiation and stores determined contrast agent protocol information (quantity, flow rate, injection administration timing profile) in repository 17. A positive contrast agent has a density greater than blood and tissue and a negative contrast agent has a density less than blood and tissue. A positive contrast agent is contrast agent that is denser than the surrounding blood or tissues: Iodine, Barium, and Gadolinium are examples of a positive contrast agent. Positive contrast agent is visible in the image as darker (lower intensity) pixels. A negative contrast agent is contrast agent that is less dense than the surrounding blood or tissues, air, Oxygen, and CO₂ are examples of negative contrast agent. A negative contrast agent is visible in the image as lighter (higher luminance intensity) pixels.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouth, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-5 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system automatically determines patient and imaging scanning procedure specific contrast agent injection protocol parameters including contrast agent type, specific contrast agent to use, bolus imaging delay from start of introduction of agent bolus, injection protocol and flow rate together with an X-ray tube voltage using a repository of predetermined information to minimize both contrast agent and radiation dose administered to a patient. Further, the processes and applications may, in alternative embodiments, be located on one or more (e.g., distributed) processing devices on a network linking the units of FIG. 1. Any of the functions and steps provided in FIGS. 1-5 may be implemented in hardware, software or a combination of both.

What is claimed is:

1. A system for automatically adaptively determining contrast agent administration parameters for use in an X-ray radiation imaging system for acquiring data representing a plurality of individual images of patient anatomy in the presence of a contrast agent, comprising:
a repository of predetermined information associating,
a contrast agent type,
contrast agent administration parameters,
an imaging system X-ray tube voltage and
at least one of, (a) a type of imaging procedure and (b) an anatomical region to be imaged;
an input processor for receiving data identifying a type of imaging procedure or an anatomical region to be imaged; and
an imaging processor for using said information in automatically identifying contrast agent parameters and X-ray tube voltage in response to the received data; and
an output processor for providing output data to a destination device indicating contrast agent parameters for use in administering contrast agent to a patient.

2. A system according to claim 1, wherein
said repository of predetermined information associates contrast agent administration parameters providing a substantially minimum contrast agent quantity for administration with an imaging system X-ray tube voltage providing adequate image quality for the type of imaging procedure and anatomical region to be imaged and
said imaging processor uses said information in automatically identifying said substantially minimum contrast agent quantity and imaging system X-ray tube voltage in response to the received data.

3. A system according to claim 1, wherein
said repository of predetermined information associates contrast agent administration parameters providing a substantially minimum contrast agent quantity for administration with a substantially minimum imaging system X-ray tube voltage providing adequate image quality for the type of imaging procedure and anatomical region to be imaged and
said imaging processor uses said information in automatically identifying said substantially minimum contrast agent quantity and said substantially minimum imaging system X-ray tube voltage.

4. A system according to claim 2, wherein
said repository of predetermined information associates contrast agent administration parameters comprising a substantially minimum contrast agent flow rate for administration with an imaging system X-ray tube voltage providing adequate image quality for the type of imaging procedure and anatomical region to be imaged and
said imaging processor uses said information in automatically identifying said substantially minimum contrast agent flow rate and imaging system X-ray tube voltage in response to the received data.

5. A system according to claim 1, wherein
said repository of predetermined information associates a plurality of different contrast agent types with contrast agent administration parameters and with an imaging system X-ray tube voltage providing adequate image quality for the type of imaging procedure and anatomical region to be imaged and
said imaging processor uses said information in automatically selecting a type of contrast agent from said plurality of different contrast agent types and substantially minimum contrast agent quantity and imaging system X-ray tube voltage in response to the received data.

6. A system according to claim 1, wherein
said repository of predetermined information associates a plurality of patient specific parameters with contrast agent administration parameters and with an imaging system X-ray tube voltage providing adequate image quality for the type of imaging procedure and anatomical region to be imaged and
said imaging processor uses said information in automatically selecting a substantially minimum contrast agent quantity or flow rate and imaging system X-ray tube voltage in response to the received data and parameters of the specific patient to be imaged.

7. A system according to claim 6, wherein
said imaging processor automatically acquires said patient specific parameters from a medical record of the patient to be imaged.

8. A system according to claim 6, wherein
said patient specific parameters comprise at least one of, (a) age, (b) height, (c) weight, (d) gender, (e) pregnancy status, (f) vessel condition and (g) diagnostic information indicating a medical condition of the patient.

9. A system according to claim 1, wherein
said repository of predetermined information associates a plurality of image scanning parameters with contrast agent administration parameters and with an imaging system X-ray tube voltage providing adequate image quality for the type of imaging procedure and anatomical region to be imaged and
said imaging processor uses said information in automatically selecting a substantially minimum contrast agent quantity or flow rate and imaging system X-ray tube voltage in response to the received data and a selected image scanning parameter.

10. A system according to claim 9, wherein
said selected image scanning parameter comprises at least one of, (a) an X-ray tube current, (b) pitch, (c) scan time, (d) tube current modulation, (e) rotation time and (f) scan mode.

11. A system according to claim 1, wherein
said X-ray radiation imaging system comprises a computed tomography (CT) system.

12. A method for automatically adaptively determining contrast agent administration parameters for use in an X-ray radiation imaging system for acquiring data representing a plurality of individual images of patient anatomy in the presence of a contrast agent, comprising the activities of
storing predetermined information in a repository, said information associating,
a contrast agent type,
contrast agent administration parameters,
an imaging system X-ray tube voltage and
at least one of, (a) a type of imaging procedure and (b) an anatomical region to be imaged;
receiving data identifying a type of imaging procedure or an anatomical region to be imaged; and
using said information in automatically identifying contrast agent parameters to substantially minimize contrast agent quantity or flow rate for administration to a patient and identifying an X-ray tube voltage, providing adequate image quality for the type of imaging procedure and anatomical region to be imaged in response to the received data; and
providing output data to a destination device indicating contrast agent parameters for use in administering contrast agent to a patient.

13. A method according to claim 12, including the activity of
using said information in automatically identifying a substantially minimum X-ray tube voltage providing adequate image quality for the type of imaging procedure and anatomical region to be imaged in response to the received data.

14. A method according to claim 12, wherein
said repository of predetermined information associates contrast agent administration parameters providing a substantially minimum contrast agent quantity for administration with a substantially minimum imaging system X-ray tube voltage providing adequate image quality for the type of imaging procedure and anatomical region to be imaged and including the activity of
using said information in automatically identifying said substantially minimum contrast agent quantity and said substantially minimum imaging system X-ray tube voltage.

15. A method according to claim 12, wherein
said repository of predetermined information associates contrast agent administration parameters comprising a substantially minimum contrast agent flow rate for administration with an imaging system X-ray tube voltage providing adequate image quality for the type of imaging procedure and anatomical region to be imaged and including the activity of
using said information in automatically identifying said substantially minimum contrast agent flow rate and imaging system X-ray tube voltage in response to the received data.

16. A method according to claim 12, wherein
said repository of predetermined information associates a plurality of different contrast agent types with contrast agent administration parameters and with an imaging system X-ray tube voltage providing adequate image quality for the type of imaging procedure and anatomical region to be imaged and including the activity of
using said information in automatically selecting a type of contrast agent from said plurality of different contrast agent types and substantially minimum contrast agent quantity and imaging system X-ray tube voltage in response to the received data.

17. A method according to claim 12, wherein
said repository of predetermined information associates a plurality of patient specific parameters with contrast agent administration parameters and with an imaging system X-ray tube voltage providing adequate image quality for the type of imaging procedure and anatomical region to be imaged and including the activity of
using said information in automatically selecting a substantially minimum contrast agent quantity or flow rate and imaging system X-ray tube voltage in response to the received data and parameters of the specific patient to be imaged.

18. A method according to claim 17, including the activity of
automatically acquiring said patient specific parameters from a medical record of the patient to be imaged.

19. A method according to claim 17, wherein
said patient specific parameters comprise at least one of (a) age, (b) height, (c) weight, (d) gender, (e) pregnancy status, (f) vessel condition and (g) diagnostic information indicating a medical condition of the patient.

20. A method according to claim 12, wherein
said repository of predetermined information associates a plurality of image scanning parameters with contrast agent administration parameters and with an imaging system X-ray tube voltage providing adequate image quality for the type of imaging procedure and anatomical region to be imaged and including the activity of
using said information in automatically selecting a substantially minimum contrast agent quantity or flow rate and imaging system X-ray tube voltage in response to the received data and a selected image scanning parameter.

21. A method according to claim 20, wherein
said selected image scanning parameter comprises at least one of, (a) an X-ray tube current, (b) pitch, (e) scan time, (d) tube current modulation, (e) rotation time and (f) scan mode.
